(19) United States
(12) Patent Application Publication
(10) Pub. No.: US 2024/0183262 A1
(43) Pub. Date: Jun. 6, 2024

(54) COMPREHENSIVE ENERGY MANAGEMENT METHOD AND SYSTEM, WELL SITE BASED ON METHOD, AND WELL SITE CONTROL METHOD

(71) Applicant: Yantai Jereh Petroleum Equipment & Technologies Co., Ltd., Yantai (CN)

(72) Inventors: Weiliang CHEN, Yantai (CN); Jianglei ZOU, Yantai (CN); Hongli WANG, Yantai (CN); Yu QU, Yantai (CN); Qingren LIN, Yantai (CN); Wanli DONG, Yantai (CN)

(73) Assignee: Yantai Jereh Petroleum Equipment & Technologies Co., Ltd., Yantai (CN)

(21) Appl. No.: 18/395,783

(22) Filed: Dec. 26, 2023

Related U.S. Application Data
(63) Continuation of application No. PCT/CN2022/129211, filed on Nov. 2, 2022.

(30) Foreign Application Priority Data
Jun. 28, 2022 (CN) 202210778102.0

(51) Int. Cl. E21B 44/00

(52) U.S. Cl. CPC E21B 44/00

(57) ABSTRACT

The present disclosure relates to the technical field of well site energy management, and in particular to a comprehensive energy management system and method for the fields of oil and gas field drilling and oil and gas field yield increase business. The energy device adopted by the application combines all power energies on site, thus realizing an integrated centralized control strategy of energy. The purpose of strong resistance to load fluctuation, and peak storage and valley release of electric energy is achieved. A cloud server is adopted to seamlessly combine site with local control, so that manual remote operation is realized. The problem that personnel cannot reach the site to handle faults, and consequently, loss is caused due to shutdown is solved. Limited resources are reasonably utilized to the greatest extent.

### CROSS-REFERENCE TO RELATED APPLICATIONS

This application is a continuation of PCT international patent application PCT/CN2022/129211 filed on Nov. 2, 2022, which claims the priority of Chinese Patent Application No. 202210778102.0 filed on Jun. 28, 2022, each of which is hereby incorporated by reference as a part of this application.

### TECHNICAL FIELD

The present disclosure relates to the technical field of well site energy management, and in particular to a comprehensive energy management system and method for the fields of oil and gas field drilling and oil and gas field yield increase business.

### BACKGROUND

Oil fracturing has experienced the era of diesel-driven fracturing, high-voltage-motor-driven fracturing, and low-voltage-motor-driven fracturing. In a system of a low-voltage-motor-driven fracturing pump, a power supply part adopts a 600 V alternating-current system, which has the characteristics that: a power generation subsystem adopts an alternating-current power frequency synchronous generator set; a power transmission and distribution subsystem adopts alternating-current power frequency grid power equipment; a power transformation and distribution subsystem adopts an alternating-current power frequency transformer power distribution device; a driving subsystem adopts a frequency converter; the system has no energy storage subsystem; and an energy management subsystem adopts a basic energy management system, and is provided with a generator parallel operation system and a power limiting system to realize the monitoring and basic energy scheduling functions of the whole system. The system has many disadvantages, multi generator sets are connected in parallel, which leads to poor stability, poor impact resistance of the system, and large capacity of reactive power in the system, resulting in low transmission efficiency, large harmonics of the system, large capacity of equipment, large investment, shortened service life of equipment, and influence on other control systems.

With the rapid development of science and technology, the integrated thinking of a comprehensive energy management system in the fields of oil and gas field drilling and oil and gas field yield increase business is particularly important. Compared with that a conventional energy unit is single, the energy consumption of a load terminal cannot be recycled, resources are consumed, the labor input cost is high, etc., a well site comprehensive energy management system gradually becomes one of the main energy management modes in the fields of oil and gas field drilling and yield increase business, particularly in mountainous and hilly areas, desolate and uninhabited deserts or muddy marsh areas where state grid power equipment is difficult to lay.

### SUMMARY

Embodiments of the present disclosure provide a comprehensive energy management method and system, a well site based on the method, and a well site control method, for realizing comprehensive energy management of the well site.

In a first aspect, a comprehensive energy management method is provided, including: a data acquisition step for acquiring power consumption demand information; a power supply confirmation step for acquiring power supply capacity information; and a power supply matching step for matching the power supply capacity information with the power consumption demand information.

As at least one alternative embodiment, the data acquisition step executes the following operations: responding to power consumption demand information input from outside, wherein the power consumption demand information input from outside includes at least one power consumption demand data, and any power consumption demand data at least includes at least two of demand voltage, demand power, demand current; responding to main classification information input from outside, wherein the main classification information includes any one of voltage, current, power and the like; distinguishing the at least one power consumption demand data; outputting the power consumption demand information.

As at least one alternative embodiment, the power supply confirmation step executes the following operations: responding to power supply capacity information input from outside, wherein the power supply capacity information input from outside includes at least one power supply capacity data, and any power supply capacity data at least includes at least two of power supply voltage, power supply power, power supply current; distinguishing the at least one power supply capacity data; outputting the power supply capacity information.

As at least one alternative embodiment, the power supply matching step executes the following operations: invoking the power supply capability information and the power consumption demand information; invoking the main classification information; judging whether power supply capacity data with a main classification information value equal to that in the power consumption demand information exists in the power supply capacity information or not, when a judging result is that the power supply capacity data with the main classification information value equal to that in the power consumption demand information exists in the power supply capacity information, marking the power supply capability data as power supply match data, marking the judged power consumption demand data as power consumption match data, and issuing match information, wherein the match information includes the power supply match data and the power consumption match data; when the judging result is that the power supply capacity data with the main classification information value equal to that in the power consumption demand information does not exist in the power supply capacity information, issuing alert information; repeating above operations until all the power supply capability data in the power supply capacity information is traversed or all the power consumption demand data in the power consumption demand information is traversed; grouping the match information according to the main classification information value to form a plurality of match information groups; outputting all the match information groups.

As at least one alternative embodiment, the power supply matching step further executes the following operations: invoking the match information groups, judging whether a value of data other than the main classification information in all power supply capability data in the power supply match data is greater than or equal to a value of data other than the main classification information in the demand match data or not, when a judging result is that the value of data other than the main classification information in all power supply capability data in the power supply match data is greater than or equal to the value of data other than the main classification information in the demand match data, selecting one or more power supply match data in the same match information group to form a power supply confirmation group with all values closest to and greater than a value of the demand match data in the match information group, and outputting the power supply confirmation group; when the judging result is that the value of data other than the main classification information in all power supply capability data in the power supply match data is not greater than or equal to the value of data other than the main classification information in the demand match data, outputting alert information.

As at least one alternative embodiment, the power supply matching step further executes the following operations: invoking the match information groups, judging whether a value of data other than the main classification information in all power supply capability data in the power supply match data is greater than or equal to a value of data other than the main classification information in the demand match data or not, when a judging result is that the value of data other than the main classification information in all power supply capability data in the power supply match data is greater than or equal to the value of data other than the main classification information in the demand match data, judging whether any individual power supply match data is identical in value to the demand match data or not, when a judging result is that any individual power supply match data is identical in value to the demand match data, associating the power supply match data and the demand match data into a power supply confirmation group, outputting the power supply confirmation group, when the judging result is that any individual power supply match data is not identical in value to the demand match data, responding deviation threshold information input from the outside, invoking a plurality of power supply match data in the same match information group, performing operation, confirming a plurality of power supply match data with values of all data greater than value of corresponding data of the demand match data and each data difference with absolute value within a range of the deviation threshold information, marking as a power supply candidate confirmation group, and outputting the candidate confirmation group; when there is more than one candidate confirmation group in the same match information group, responding to judging information input from the outside, confirming a candidate confirmation group finally through calculation or judgment, marking as a power supply confirmation group, and outputting the power supply confirmation group.

As at least one alternative embodiment, the judging information includes any one or more of the following selection methods: selecting from all of the power supply confirmation groups, one group having the least power capability data; selecting from all of the power supply confirmation groups, one group with a highest similarity to the corresponding demand match data.

In a second aspect, a comprehensive energy management system is provided, including: input equipment, configured to input information; output equipment, configured to display information; storage equipment, configured to store information, the storage equipment is one or more of local storage equipment, network storage equipment, or cloud storage equipment; processing equipment, configured to perform information operations, judgment, or other processing; both the input equipment and the output equipment are in signal connection with the processing equipment, and the processing equipment is in signal connection with the storage equipment.

In a third aspect, A well site is provided, including: at least one power supply equipment, the power supply equipment at least includes any one or a combination of a plurality of equipment such as a generator, grid power equipment, energy storage equipment, a fuel cell; any power supply equipment is capable of outputting power supply capability information; load equipment, including one or more of oil and gas collecting equipment, including fracturing equipment, sand mixing equipment and cementing equipment, and any load equipment is capable of outputting power consumption demand information; processing equipment capable of performing data processing according to the above comprehensive energy management method.

As at least one alternative embodiment, the well site according to claim 9, wherein the power supply equipment includes energy storage equipment which is electrically connected to one or more power supply equipment, and the energy storage equipment can be used as a blackstart for any of the power supply equipment.

As at least one alternative embodiment, the load equipment includes energy storage equipment which is electrically connected to both the power supply equipment and any other load equipment.

In a fourth aspect, a well site control method applied to the well site is provided, wherein the well site control method includes: responding to power supply confirmation group information input from outside, electrically connecting power supply equipment corresponding to power supply capability information in a power supply confirmation group and load equipment corresponding to power consumption demand information.

Through the technical solutions, the energy device adopted by the present patent combines all energies providing power on site, thus realizing an integrated centralized control strategy of energy. The purpose of strong resistance to load fluctuation, and peak storage and valley release of electric energy is achieved. An energy comprehensive management method is provided.

It is to be noted that the method described above may be stored in whole or in part on a computer-readable storage medium. The computer-readable storage medium may be packaged together with or separately from a processor of a controller, as is not limited herein.

### BRIEF DESCRIPTION OF THE DRAWINGS

The drawings are provided to provide a further understanding of the technical solutions of the present disclosure and constitute a part of this specification, and together with the embodiments of the present disclosure, serve to explain the technical solutions of the present disclosure but do not constitute a limitation of the technical solutions of the present disclosure.

FIG. 1 is a schematic structure diagram illustrating a connection of a well site comprehensive energy management system provided by an embodiment of the present disclosure.

FIG. 2 is a flowchart of a well site comprehensive energy management method provided by an embodiment of the present disclosure.

### DESCRIPTION OF REFERENCE NUMERALS

1. Energy system; 101. Generator system; 102. Energy storage system; 103. Grid power system; 104. Wind/light power generation system; 105. Grid-connected synchronization device;

2. Energy control system; 201. Cloud server; 202. Dispatch center; 203. Power management system; 204. ERP system; 205. DCS system;

3. Load terminal equipment; 301. Electrically-driven fracturing equipment; 302. Electrically-driven sand mixing equipment; 303. Cementing equipment; and 304. Drill repair machine.

### DETAILED DESCRIPTION OF THE EMBODIMENTS

The technical solutions in the embodiments of the present disclosure will be clearly and completely described below in combination with the drawings in the embodiments of the present disclosure. It is apparent that the described embodiments are not all but part of embodiments of the present disclosure. All other embodiments obtained by those of ordinary skill in the art based on the embodiments of the present disclosure without creative efforts shall fall within the protection scope of the present disclosure.

In the description of the present disclosure, it is to be noted that unless otherwise definitely specified and limited, terms “mutually connect” and “connect” should be broadly understood. For example, the terms may refer to fixed connection and may also refer to detachable connection or integration. For those of ordinary skill in the art, specific meanings of these terms in the present disclosure can be understood according to a specific condition.

In embodiments of the present disclosure, the terms “exemplary” or “for example” are used to mean serving as an example, instance, or illustration. Any embodiment or design solution described in the embodiments herein as “exemplary” or as “for example” is not necessarily to be construed as preferred or advantageous over other embodiments or design solutions. Rather, use of the words “exemplary” or “for example” is intended to present related concepts in a concrete fashion.

The embodiments of the present disclosure provide a comprehensive energy management method, for realizing comprehensive energy management of a well site.

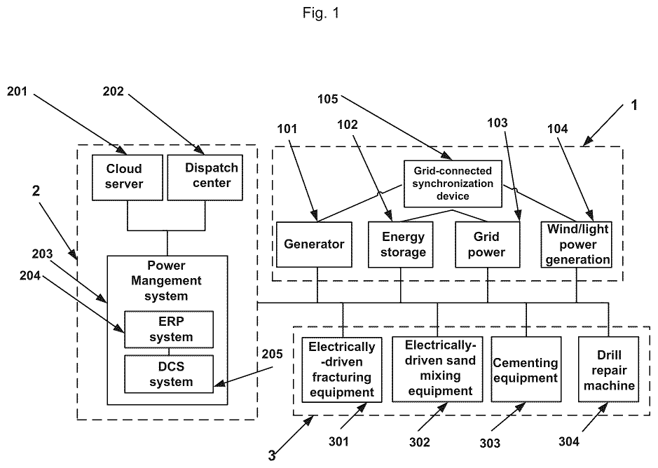

Embodiment 1: as shown in FIG. 1, the comprehensive energy management method includes a data acquisition step for acquiring power consumption demand information;

The data acquisition step specifically executes the following operations.

Power consumption demand information input from the outside is responded, the power consumption demand information includes at least one power consumption demand data, and any power consumption demand data at least includes at least two of information such as demand voltage, demand power, demand current and the like.

Main classification information input from the outside is responded, and the main classification information includes any one of voltage, current, power and the like.

All the power consumption demand data is distinguished. The method of distinguishing may be sequential numbering or other means of distinguishing.

The power consumption demand information is output.

The power consumption demand information may be sent directly by load equipment, and also can be entered manually by a worker, the load equipment may be any power consumption equipment; and the main classification information may be any data type included in the power consumption demand data specified by an operator, with voltage data as an example in the embodiment.

A power supply confirmation step for acquiring power supply capacity information;

The power supply confirmation step specifically executes the following operations.

Power supply capacity information input from the outside is responded, the power supply capacity information includes at least one power supply capacity data, and any power supply capacity data at least includes at least two of information such as power supply voltage, power supply power, power supply current and the like.

All the power supply capacity data is distinguished.

The power supply capacity information is output.

The power supply capability information may be sent directly by power supply equipment, and also can be entered manually by a worker, the power supply equipment at least includes any one or a combination of a plurality of equipment such as a generator, grid power equipment, energy storage equipment, a fuel cell and the like, and any power supply equipment can be one or more.

A power supply matching step for matching the power supply capacity information with the power consumption demand information.

The power supply matching step specifically executes the following operations:

The power supply capability information and power consumption demand information are invoked.

The main classification information is invoked.

Whether power supply capacity data with a main classification information value equal to that in the power consumption demand information exists in the power supply capacity information or not is judged, if yes, the power supply capability data is marked as power supply match data, the judged power consumption demand data is marked as power consumption match data, match information is issued, and the match information includes the power supply match data and the power consumption match data; and the match information is provided with distinguishing symbols for distinguishing different match information.

If not, alert information is issued, which is instructional information, with the expression form being one or more of sound, light, display information and the like.

The above operations are repeated until all the power supply capability data in the power supply capacity information is traversed or all the power consumption demand data in the power consumption demand information is traversed.

The match information is grouped according to the main classification information value to form a plurality of match information groups.

The data values corresponding to the main classification information of all match information in each match information group are the same, for example, when the main classification information is voltage information, the values of power supply voltage and demand voltage included in all match information in each match information group are equal.

All the match information groups are output.

The match information groups are invoked, whether a value of data other than the main classification information in all power supply capability data in the power supply match data is greater than or equal to a value of data other than the main classification information in the demand match data or not is judged.

If yes, one or more power supply match data in the same match information group is selected to form a power supply confirmation group with all values closest to and greater than the demand match data value in the match information group, and the power supply confirmation group is output.

If not, alert information is output.

The judging information is: one power supply confirmation group having the least power supply capability data is selected from all of the power supply confirmation groups.

Embodiment 2: with the difference from embodiment 1 in that one power supply confirmation group with the highest similarity to the corresponding demand match data is selected from all of the power supply confirmation groups.

Embodiment 3: with the difference from embodiment 1 in that the power supply matching step specifically executes the following operations.

The power supply capability information and power consumption demand information are invoked.

The main classification information is invoked.

Whether power supply capacity data with a main classification information value equal to that in the power consumption demand information exists in the power supply capacity information or not is judged, if yes, the power supply capability data is marked as power supply match data, the judged power consumption demand data is marked as power consumption match data, match information is issued, the match information includes the power supply match data and the power consumption match data, and the match information is provided with distinguishing symbols for distinguishing different match information.

If not, alert information is issued, which is instructional information, with the expression form being one or more of sound, light, display information and the like.

The above operations are repeated until all the power supply capability data in the power supply capacity information is traversed or all the power consumption demand data in the power consumption demand information is traversed.

The match information is grouped according to the main classification information value to form a plurality of match information groups, the data values corresponding to the main classification information of all match information in each match information group are the same, for example, when the main classification information is voltage information, the values of power supply voltage and demand voltage included in all match information in each match information group are equal.

All the match information groups are output.

The match information groups are invoked, whether a value of data other than the main classification information in all power supply capability data in the power supply match data is greater than or equal to a value of data other than the main classification information in the demand match data or not is judged.

If yes, whether any individual power supply match data is identical in value to the demand match data or not is judged, if yes, the power supply match data and the demand match data are associated into a power supply confirmation group, the power supply confirmation group is output, if not, deviation threshold information input from the outside is responded, a plurality of power supply match data in the same match information group is invoked, operation is performed, a plurality of power supply match data with all data greater than corresponding data of the demand match data and each data difference with absolute value within a deviation threshold information range is judged and marked as a power supply candidate confirmation group, and a candidate confirmation group is output.

If there is more than one candidate confirmation group in the same match information group, judging information input from the outside is responded, a candidate confirmation group is confirmed finally through calculation or judgment, and marked as a power supply confirmation group, and the power supply confirmation group is output.

The judging information is: one power supply candidate confirmation group having the least power supply capability data is selected from all of the power supply confirmation groups.

Embodiment 4: with the difference from Embodiment 3 in that one power supply confirmation group with the highest similarity to the corresponding demand match data is selected from all of the power supply confirmation groups.

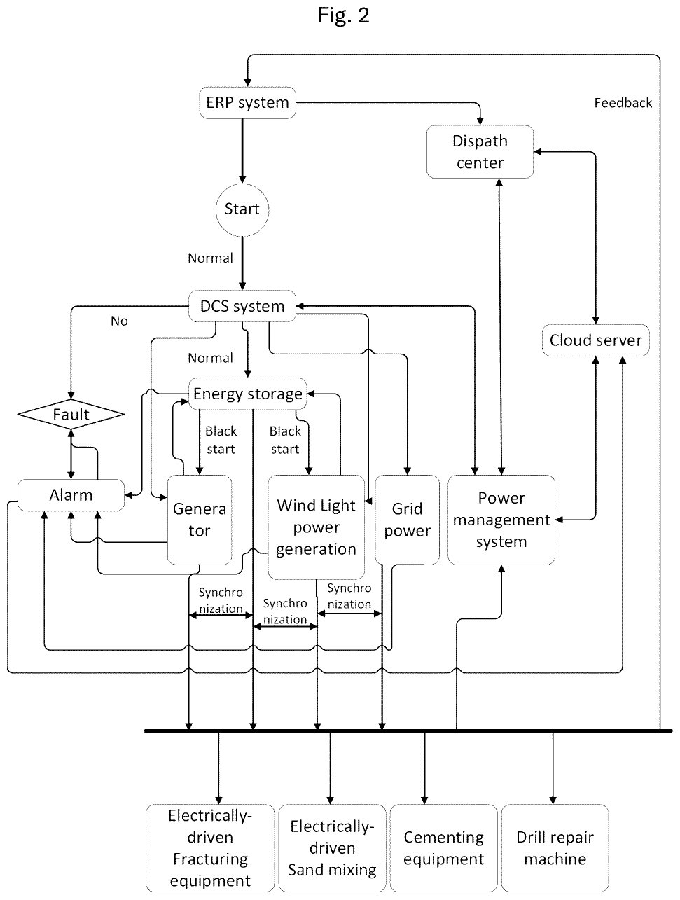

Embodiment 5: as shown in FIG. 1 and FIG. 2, the embodiment discloses a comprehensive energy management method system, which includes input equipment, output equipment, storage equipment and processing equipment.

The input equipment is configured to input information. In the embodiment, the input equipment includes output end of voltage, current and power of a generator set, grid power, wind/light power generation and energy storage equipment, and a keyboard.

The output equipment is configured for displaying information.

The storage equipment is configured for storing information, the storage equipment may be one or more of local storage equipment, network storage equipment, or cloud storage equipment; and in the embodiment, the storage equipment includes cloud storage equipment of a cloud server 201 and local storage equipment of a dispatch center.

The processing equipment is configured for performing information operations, judgment, or other processing; and in the embodiment, the processing equipment further includes an ERP system 204 and a DCS system 205, which are used for data processing and judgment.

In the embodiment, the system further includes a cloud server 201 and a dispatch center, the cloud server 201 and the dispatch center are in signal connection with the processing equipment for remote control and storage.

Both the input equipment and the output equipment are in signal connection with the processing equipment, and the processing equipment is in signal connection with the storage equipment.

Embodiment 6: as shown in FIG. 1 and FIG. 2, the embodiments disclose a well site, which includes power supply equipment, load equipment and processing equipment.

All the power supply equipment may output power supply capacity information through a grid-connected synchronization device 105.

The load equipment includes oil and gas collecting equipment, such as electrically-driven fracturing equipment 301, electrically-driven sand mixing equipment 302, electrically-driven cementing equipment 303, and a drill repair machine 304, and all the load equipment can output power consumption demand information.

The processing equipment is capable of performing data processing in accordance with the comprehensive energy management method of any one of Embodiments 1-4 described above.

In the embodiment, the power supply equipment includes a generator 101, wind/light power generation equipment 104, and grid power equipment 103, the well site further includes energy storage equipment 102, which is connected to the generator 101, the wind/light power generation equipment 104, respectively and used as a blackstart of the power supply equipment, and meanwhile, the energy storage equipment 102, serving as load equipment of the three power supply equipment, is capable of acquiring electrical energy from any one of the power supply equipment.

Embodiment 7: as shown in FIG. 2, the embodiment includes a well site control method, which specifically includes the following operations.

A dispatch center and a power management system 203 respond to power supply confirmation group information input from the outside, the power supply confirmation group information comes from load equipment such as electrically-driven fracturing equipment 301 and electrically-driven sand mixing equipment 302 and power supply equipment such as grid power equipment 103 and wind/light power generation equipment 104, the dispatch center 202 and the DCS system 205 send information for electrically connecting power supply equipment corresponding to power supply capacity information in the power supply confirmation group and load equipment corresponding to power consumption demand information, and then the corresponding equipment can be electrically connected in a manual or electric control mode.

In the several embodiments provided in the application, it should be understood that the disclosed device and method may be implemented in other manners. For example, the device embodiment described above is only schematic, and for example, division of the modules or units is only logic function division, and other division manners may be adopted during practical implementation. For example, multiple units or components may be combined or integrated into another device, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms. The units described as separate parts may or may not be physically separate, and parts displayed as units may be one or more physical units, may be located in one position, or may be distributed in a plurality of different positions. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit. The integrated unit may be implemented in a hardware form and may also be implemented in form of software functional unit. When being implemented in form of software functional unit and sold or used as an independent product, the integrated unit may be stored in a computer-readable storage medium. Based on such an understanding, the technical solutions of the embodiments of the present disclosure essentially, or the part contributing to the prior art, or all or part of the technical solutions may be implemented in a form of a software product. The software product is stored in a storage medium and includes several instructions for instructing a device (which may be a single chip microcomputer or a chip) or a processor to perform all or some of the steps of the methods described in the embodiments of the present disclosure. The foregoing storage medium includes any medium that can store program code, such as a U disk, a removable hard disk, an ROM, an RAM, a magnetic disk, or an optical disc.

The above is only the specific implementation modes of the present disclosure and not intended to limit the scope of protection of the present disclosure. Any variations or replacements within the technical scope disclosed by the present disclosure shall fall within the scope of protection of the present disclosure. Therefore, the scope of protection of the present disclosure shall be subjected to the scope of protection of the claims.

What is claimed is:

1. A comprehensive energy management method, comprising:
a data acquisition step for acquiring power consumption demand information;
a power supply confirmation step for acquiring power supply capacity information; and
a power supply matching step for matching the power supply capacity information with the power consumption demand information.

2. The comprehensive energy management method according to claim 1, wherein the data acquisition step executes the following operations:
responding to power consumption demand information input from outside, wherein the power consumption demand information input from outside comprises at least one power consumption demand data, and any power consumption demand data at least comprises at least two of demand voltage, demand power, demand current;
responding to main classification information input from outside, wherein the main classification information comprises any one of voltage, current, power and the like;
distinguishing the at least one power consumption demand data;
outputting the power consumption demand information.

3. The comprehensive energy management method according to claim 2, wherein the power supply confirmation step executes the following operations:
responding to power supply capacity information input from outside, wherein the power supply capacity information input from outside comprises at least one power supply capacity data, and any power supply capacity data at least comprises at least two of power supply voltage, power supply power, power supply current;
distinguishing the at least one power supply capacity data;
outputting the power supply capacity information.

4. The comprehensive energy management method according to claim 3, wherein the power supply matching step executes the following operations:
invoking the power supply capability information and the power consumption demand information;
invoking the main classification information;
judging whether power supply capacity data with a main classification information value equal to that in the power consumption demand information exists in the power supply capacity information or not, when a judging result is that the power supply capacity data with the main classification information value equal to that in the power consumption demand information exists in the power supply capacity information, marking the power supply capability data as power supply match data, marking the judged power consumption demand data as power consumption match data, and issuing match information, wherein the match information comprises the power supply match data and the power consumption match data;
when the judging result is that the power supply capacity data with the main classification information value equal to that in the power consumption demand information does not exist in the power supply capacity information, issuing alert information;
repeating above operations until all the power supply capability data in the power supply capacity information is traversed or all the power consumption demand data in the power consumption demand information is traversed;
grouping the match information according to the main classification information value to form a plurality of match information groups;
outputting all the match information groups.

5. The comprehensive energy management method according to claim 4, wherein the power supply matching step further executes the following operations:
invoking the match information groups, judging whether a value of data other than the main classification information in all power supply capability data in the power supply match data is greater than or equal to a value of data other than the main classification information in the demand match data or not,
when a judging result is that the value of data other than the main classification information in all power supply capability data in the power supply match data is greater than or equal to the value of data other than the main classification information in the demand match data, selecting one or more power supply match data in the same match information group to form a power supply confirmation group with all values closest to and greater than a value of the demand match data in the match information group, and outputting the power supply confirmation group;
when the judging result is that the value of data other than the main classification information in all power supply capability data in the power supply match data is not greater than or equal to the value of data other than the main classification information in the demand match data, outputting alert information.

6. The comprehensive energy management method according to claim 4, wherein the power supply matching step further executes the following operations:
invoking the match information groups, judging whether a value of data other than the main classification information in all power supply capability data in the power supply match data is greater than or equal to a value of data other than the main classification information in the demand match data or not,
when a judging result is that the value of data other than the main classification information in all power supply capability data in the power supply match data is greater than or equal to the value of data other than the main classification information in the demand match data, judging whether any individual power supply match data is identical in value to the demand match data or not, when a judging result is that any individual power supply match data is identical in value to the demand match data, associating the power supply match data and the demand match data into a power supply confirmation group, outputting the power supply confirmation group, when the judging result is that any individual power supply match data is not identical in value to the demand match data, responding deviation threshold information input from the outside, invoking a plurality of power supply match data in the same match information group, performing operation, confirming a plurality of power supply match data with values of all data greater than value of corresponding data of the demand match data and each data difference with absolute value within a range of the deviation threshold information, marking as a power supply candidate confirmation group, and outputting the candidate confirmation group;
when there is more than one candidate confirmation group in the same match information group, responding to judging information input from the outside, confirming a candidate confirmation group finally through calculation or judgment, marking as a power supply confirmation group, and outputting the power supply confirmation group.

7. The comprehensive energy management method according to claim 6, wherein the judging information comprises any one or more of the following selection methods:
selecting from all of the power supply candidate confirmation groups, one group having the least power capability data;
selecting from all of the power supply candidate confirmation groups, one group with a highest similarity to the corresponding demand match data.

8. A well site, comprising:
at least one power supply equipment, the power supply equipment at least comprises any one or a combination of a plurality of equipment such as a generator, grid power equipment, energy storage equipment, a fuel cell;
any power supply equipment is capable of outputting power supply capability information;
load equipment, comprising one or more of oil and gas collecting equipment, comprising fracturing equipment, sand mixing equipment and cementing equipment, and any load equipment is capable of outputting power consumption demand information;
processing equipment capable of performing data processing according to the comprehensive energy management method with following actions:
a data acquisition step for acquiring power consumption demand information;
a power supply confirmation step for acquiring power supply capacity information; and
a power supply matching step for matching the power supply capacity information with the power consumption demand information.

9. The well site according to claim 8, wherein the power supply equipment comprises energy storage equipment which is electrically connected to one or more power supply equipment, and the energy storage equipment can be used as a blackstart for any of the power supply equipment.

10. The well site according to claim 8, wherein the load equipment comprises energy storage equipment which is electrically connected to both the power supply equipment and any other load equipment.

11. A well site control method applied to the well site according to claim 8, wherein the well site control method comprises:
responding to power supply confirmation group information input from outside, electrically connecting power supply equipment corresponding to power supply capability information in a power supply confirmation group and load equipment corresponding to power consumption demand information.

12. The well site according to claim 8, wherein the data acquisition step executes the following operations:
responding to power consumption demand information input from outside, wherein the power consumption demand information input from outside comprises at least one power consumption demand data, and any power consumption demand data at least comprises at least two of demand voltage, demand power, demand current;
responding to main classification information input from outside, wherein the main classification information comprises any one of voltage, current, power and the like;
distinguishing the at least one power consumption demand data;
outputting the power consumption demand information.

13. The well site according to claim 12, wherein the power supply confirmation step executes the following operations:
responding to power supply capacity information input from outside, wherein the power supply capacity information input from outside comprises at least one power supply capacity data, and any power supply capacity data at least comprises at least two of power supply voltage, power supply power, power supply current;
distinguishing the at least one power supply capacity data;
outputting the power supply capacity information.

14. The well site according to claim 13, wherein the power supply matching step executes the following operations:
invoking the power supply capability information and the power consumption demand information;
invoking the main classification information;
judging whether power supply capacity data with a main classification information value equal to that in the power consumption demand information exists in the power supply capacity information or not, when a judging result is that the power supply capacity data with the main classification information value equal to that in the power consumption demand information exists in the power supply capacity information, marking the power supply capability data as power supply match data, marking the judged power consumption demand data as power consumption match data, and issuing match information, wherein the match information comprises the power supply match data and the power consumption match data;
when the judging result is that the power supply capacity data with the main classification information value equal to that in the power consumption demand information does not exist in the power supply capacity information, issuing alert information;
repeating above operations until all the power supply capability data in the power supply capacity information is traversed or all the power consumption demand data in the power consumption demand information is traversed;
grouping the match information according to the main classification information value to form a plurality of match information groups;
outputting all the match information groups.

15. The well site according to claim 14, wherein the power supply matching step further executes the following operations:
invoking the match information groups, judging whether a value of data other than the main classification information in all power supply capability data in the power supply match data is greater than or equal to a value of data other than the main classification information in the demand match data or not,
when a judging result is that the value of data other than the main classification information in all power supply capability data in the power supply match data is greater than or equal to the value of data other than the main classification information in the demand match data, selecting one or more power supply match data in the same match information group to form a power supply confirmation group with all values closest to and greater than a value of the demand match data in the match information group, and outputting the power supply confirmation group;
when the judging result is that the value of data other than the main classification information in all power supply capability data in the power supply match data is not greater than or equal to the value of data other than the main classification information in the demand match data, outputting alert information.

16. The well site according to claim 14, wherein the power supply matching step further executes the following operations:
invoking the match information groups, judging whether a value of data other than the main classification information in all power supply capability data in the power supply match data is greater than or equal to a value of data other than the main classification information in the demand match data or not,
when a judging result is that the value of data other than the main classification information in all power supply capability data in the power supply match data is greater than or equal to the value of data other than the main classification information in the demand match data, judging whether any individual power supply match data is identical in value to the demand match data or not, when a judging result is that any individual power supply match data is identical in value to the demand match data, associating the power supply match data and the demand match data into a power supply confirmation group, outputting the power supply confirmation group, when the judging result is that any individual power supply match data is not identical in value to the demand match data, responding deviation threshold information input from the outside, invoking a plurality of power supply match data in the same match information group, performing operation, confirming a plurality of power supply match data with values of all data greater than value of corresponding data of the demand match data and each data difference with absolute value within a range of the deviation threshold information, marking as a power supply candidate confirmation group, and outputting the candidate confirmation group;
when there is more than one candidate confirmation group in the same match information group, responding to judging information input from the outside, confirming a candidate confirmation group finally through calculation or judgment, marking as a power supply confirmation group, and outputting the power supply confirmation group.

17. The well site according to claim 16, wherein the judging information comprises any one or more of the following selection methods:
selecting from all of the power supply candidate confirmation groups, one group having the least power capability data;
selecting from all of the power supply candidate confirmation groups, one group with a highest similarity to the corresponding demand match data.
